(19) United States
(12) Patent Application Publication
(10) Pub. No.: US 2014/0370818 A1
(43) Pub. Date: Dec. 18, 2014

(54) AUTO-DISCOVERY AND AUTO-CONFIGURATION OF MEDIA DEVICES

(71) Applicant: Michael Edward Smith Luna, San Jose, CA (US)

(72) Inventor: Michael Edward Smith Luna, San Jose, CA (US)

(73) Assignee: AliphCom

(21) Appl. No.: 13/919,339

(22) Filed: Jun. 17, 2013

(51) Int. Cl. H04W 4/00

(52) U.S. Cl. CPC H04W 4/008
USPC 455/41.3

(57) ABSTRACT

Embodiments of the present application relate generally to electrical and electronic hardware, computer software, wired and wireless network communications, wearable, hand held, and portable computing devices for facilitating communication of information. Disclosed are wireless media devices that automatically discover and automatically configure themselves to communicate with and seamlessly operate with one or more wireless devices. A backend service in communication with the media devices and/or wireless devices queries the wireless device to obtain prerequisite configuration data (P-Data) and analyzes the P-Data to generate configuration data (C-Data) that is downloaded to the media device, the wireless device, or both. The C-Data is operative to configure the media device, the wireless device, or both. The backend service may be in wireless communication with one or more of the media devices. Media devices may include a proximity detection island for detecting presence and/or proximity of wireless user devices, users, and other objects.

### CROSS-REFERENCE TO RELATED APPLICATIONS

This application is related to the following applications: U.S. patent application Ser. No. 13/831,422 filed on Mar. 14, 2013 and titled “PROXIMITY-BASED CONTROL OF MEDIA DEVICES” and having Attorney Docket Number ALI-229; U.S. patent application Ser. No. 13/802,646 filed on Mar. 13, 2013 and titled “Proximity-Based Control Of Media Devices For Media Presentations” and having Attorney Docket Number ALI-230; U.S. patent application Ser. No. 13/802,674 filed on Mar. 13, 2013 and titled “Proximity And Interface Controls Of Media Devices For Media Presentations” and having Attorney Docket Number ALI-231; U.S. patent application Ser. No. 13/831,485 filed on Mar. 14, 2013 and titled “MEDIA DEVICE CONFIGURATION AND ECOSYSTEM SETUP” and having Attorney Docket Number ALI-253; U.S. patent application Ser. No. 13/802,528 filed on Mar. 13, 2013 and titled “CLOUD-BASED MEDIA DEVICE CONFIGURATION AND ECOSYSTEM SETUP” and having Attorney Docket Number ALI-241; and U.S. patent application Ser. No. 13/802,689 filed on Mar. 13, 2013 and titled “CHARACTERISTIC-BASED COMMUNICATIONS” and having Attorney Docket Number ALI-194, all of which are hereby incorporated by reference in their entirety for all purposes.

### FIELD

Embodiments of the present application relate generally to electrical and electronic hardware, computer software, wired and wireless network communications, wearable, hand held, and portable computing devices for facilitating communication of information. More specifically, disclosed are wireless media devices that automatically discover and automatically configure themselves to communicate with and seamlessly operate with one or more wireless devices.

### BACKGROUND

With some conventional devices, such as wirelessly enabled portable devices, it is often necessary for a user to configure the device to work with a variety of other wireless devices the user may own or use. In many cases, the other wireless devices are not automatically compatible with one another or with new devices the user introduces into his/her collection of wireless devices. Differences between wireless devices that give rise to incompatibility issues include differences in operating systems (OS) or other types of software/firmware used by wireless devices, differences in hardware, and differences in communications systems and communications protocols. In cases were wireless devices share a common communications links, such as Bluetooth® (BT) for example, compatibility issues may still arise when the use scenario for BT paired devices exceeds the scope or capabilities of the BT protocols and use models. In some instances, the user must intervene to make the various wireless devices play well with one another, or worse case, the user lacks the trouble shooting skills or simply doesn't know how to make the various wireless devices work seamlessly with one another.

Thus, there is a need for devices, systems, methods, and software that enable a wireless device to automatically detect other wireless devices and automatically configure itself and/or the other wireless devices to work seamlessly with one another and with minimal or no user intervention.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1 depicts an exemplary wireless media system according to an embodiment of the present application;

FIG. 2 illustrates an exemplary computer system according to an embodiment of the present application;

FIG. 3 depicts one example of a system for auto-discovery and auto-configuration according to an embodiment of the present application;

FIG. 4 depicts one example of a backend service according to an embodiment of the present application;

FIG. 5 depicts another example of a backend service according to an embodiment of the present application;

FIG. 6 depicts one example of a flow diagram for auto-detection and auto-configuration according to an embodiment of the present application;

FIG. 7 depicts a block diagram of one example of an auto-detect and auto-configuration sequence for a media device and user device according to an embodiment of the present application; and

FIG. 8 depicts a block diagram of one example of a media device according to an embodiment of the present application.

### DETAILED DESCRIPTION

Various embodiments or examples may be implemented in numerous ways, including as a system, a process, a method, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

Auto-Discovery and Auto-Configuration

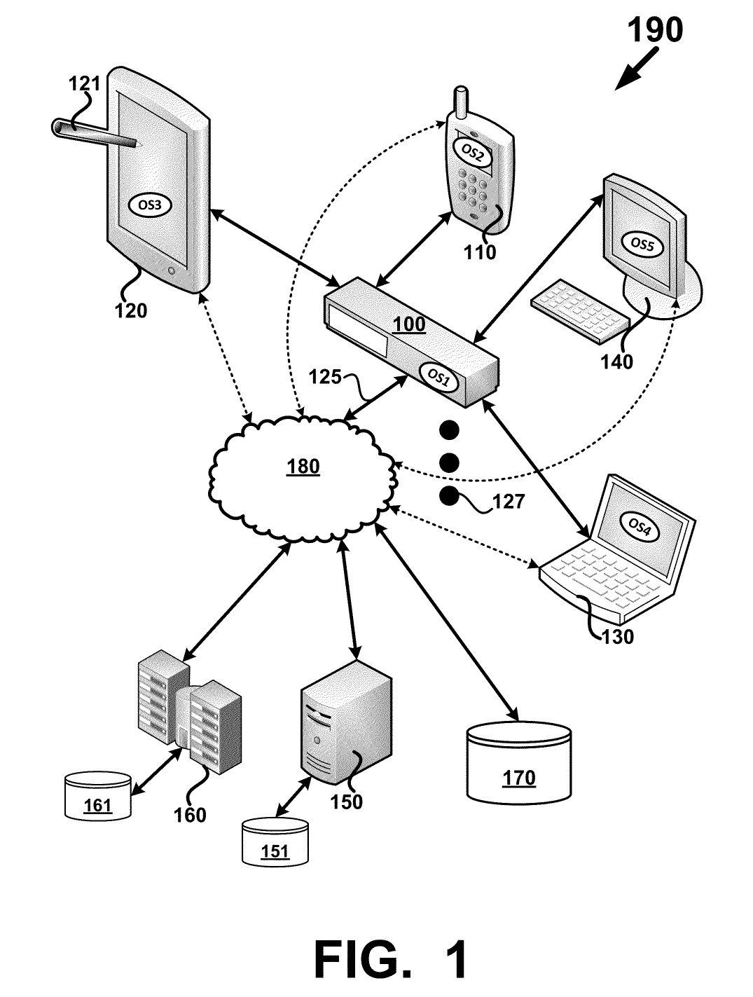

FIG. 1 depicts an exemplary wireless media system 190. Here system 190 includes a network 180 and a plurality of devices in communication with network 180 including but not limited to: a wireless media device 100; a plurality of user devices such as a smartphone 110, a tablet/pad 120, a laptop computer 130, a desktop computer 140; a server 150, a data center 160, and a storage system 170. For purposes of explanation, the user device regardless of its type will be denoted as 120. Storage system 170 may comprise one or more data storage devices including but not limited to hard disk drives (HDD), solid state drives (SSD), RAID, Flash Memory, DRAM, SRAM, RAM, volatile memory, non-volatile memory, read only memory (ROM), and optical disk, just to name a few. More than one wireless media device 100 may be included in system 190 as depicted by 127 and those wireless media devices 100 may be in communications with one another, the network 180, and user devices 110-140. Server 150 and data center 160 may optionally be in communication with data storage devices 151 and 161 respectively. Data storage devices 151 and 161 may comprise one or more data storage devices such as those described above for storage system 170.

System 190 may include other types of devices and may include more or fewer devices than depicted in FIG. 1. Data communications with network 180 may be using one or more data communications protocols including but not limited to wireless (e.g., WiFi, WiMAX, Bluetooth®, IEEE 802.11a/b/g/n, Near Field Communications (NFC), ANTI™, ZigBee®, and others) or wired (e.g., Ethernet, LAN, IEEE 1394, RS-232, FireWire, Lightning, USB, Thunderbolt™, Fiber Optic, and others). User devices 110-140 may be in communications with media device 100 as depicted by solid arrows and/or with the network 180 as depicted by dashed arrows.

Media device 100 may be in direct communication 125 with network 180 or indirect communication with network 180 via one or more of the user devices 110-140 as denoted by the solid arrows and dashed arrows. For example, media device 100 may be in communication with user device 120 (solid arrow) and user device 120 may be in communication with network 180 (dashed arrow). Media device 100, user devices 110-140, or both may access data, files, applications, executable code, configurations, or other information from one or more of the resources 150, 151, 160, 161, and 170 via network 180. Server 150 and/or data center 160, in some examples may be implemented using one or more processor-based computing devices and/or networks, including but not limited to storage area networks, RAID, cloud computing, cloud storage, server farms, just to name a few. Media device 100 and user devices 110-140 may use more than one data communications protocol to communicate with one another and with the network 180. As one example, media device 100 and user device 120 may use Bluetooth to communicate with each other and use WiFi to communicate with network 180. As another example, media device 100 and user device 130 may use Bluetooth to communicate with each other and user device 130 may use WiFi to communicate with network 180. Information from network 180 intended for media device 100 may be communicated from network 180 to user device 130 which in turn uses its Bluetooth radio to transmit the information to media device 100. Information from media device 100 intended for network 180 may be transmitted from media device 100 to user device 130 using its Bluetooth radio and user device 130 may use its WiFi radio to transmit the information to the network 180.

Each user devices 110-140 may include an operating system (OS) denoted as OS2-OS5 that may be different from one another and different than an operating system OS1 of media device 100. System 190 may be used to facilitate the auto-discovery and auto-configuration of media device 100 with the various user devices 110-140 the media device 100 may be required to communicate and operate with as will be described in greater detail below. For example, OS3 for user device 120 may be iOS, OS2 for user device 110 may be Android OS, and OS1 for media device 100 may be an OS that is different than that of OS2 and OS3 (e.g., a proprietary OS). From a standpoint of a user (not shown) of the system 190, media device 100 requires zero or substantially no intervention on part of the user to have media device 100, at power up, be able to recognize the one or more user devices 110-140 that are detectable using the wireless systems of the media device 100 and then configure itself (i.e., the media device 100) and/or the one or more user devices 110-140 using resources in communication with network 180. As will be explained in greater detail below, the media device 100 and/or the user devices 110-140 may have data downloaded into a memory system (e.g., RAM, Flash memory, or the like) that may be used to configure those devices. Data for configuring the media device 100 and/or any user devices may be by way of a configuration (CFG) or an application (APP) that may be in the form of a file, for example.

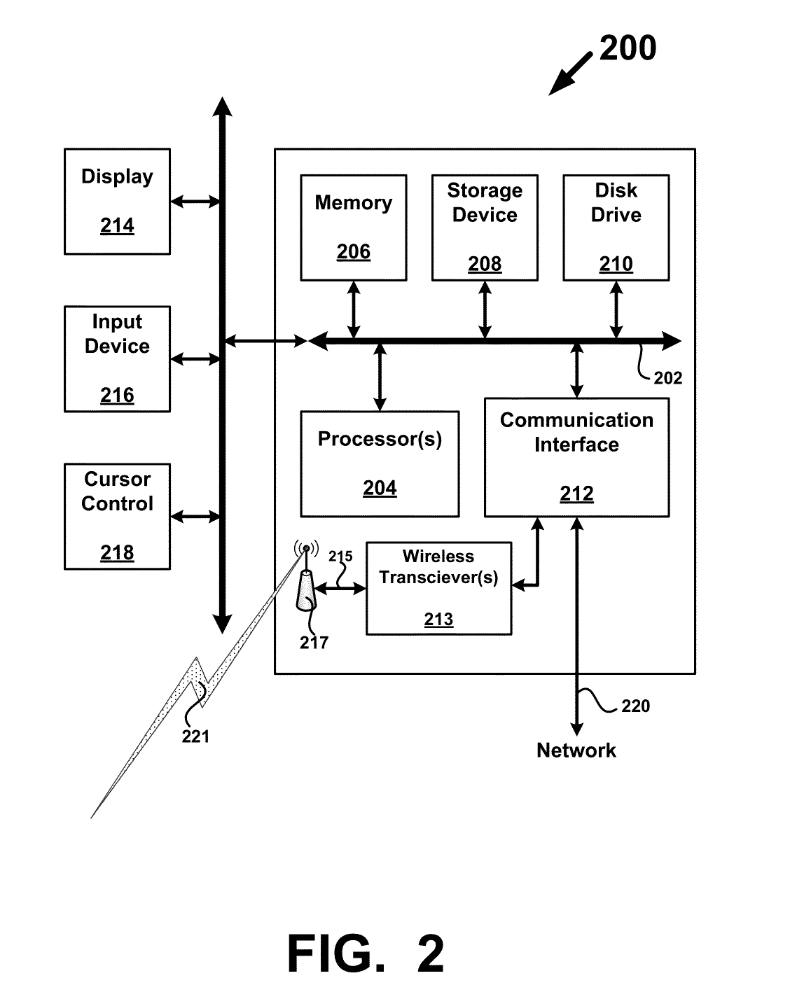

FIG. 2 illustrates an exemplary computer system 200 suitable for use in the system 190 depicted in FIG. 1. In some examples, computer system 200 may be used to implement computer programs, applications, configurations, methods, processes, or other software to perform the above-described techniques. Computer system 200 includes a bus 202 or other communication mechanism for communicating information, which interconnects subsystems and devices, such as one or more processors 204, system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi), display 214 (e.g., CRT, LCD, touch screen), input device 216 (e.g., keyboard, stylus), and cursor control 218 (e.g., mouse, trackball, stylus). Some of the elements depicted in computer system 200 may be optional, such as elements 214-218, for example and computer system 200 need not include all of the elements depicted.

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions to processor 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 202 for transmitting a computer data signal. In some examples, execution of the sequences of instructions may be performed by a single computer system 200. According to some examples, two or more computer systems 200 coupled by communication link 220 (e.g., LAN, Ethernet, PSTN, or wireless network) may perform the sequence of instructions in coordination with one another. Computer system 200 may transmit and receive messages, data, and instructions, including programs, (i.e., application code), through communication link 220 and communication interface 212. Received program code may be executed by processor 204 as it is received, and/or stored in disk drive 210, or other non-volatile storage for later execution. Computer system 200 may optionally include a wireless transceiver 213 in communication with the communication interface 212 and coupled 215 with an antenna 217 for receiving and generating RF signals 221, such as from a WiFi network, BT radio, or other wireless network and/or wireless devices, for example. Examples of wireless devices include but are not limited to those depicted in FIG. 1 such as media device 100 and user devices 110-140.

Referring back to FIG. 1, system 190 may include one or more instances of computer system 200 of FIG. 2 to implement one or more compute/processing functions such as those of server 150 or data center 160, for example. Information about a wide variety of user devices (e.g., 110-140) that the media device 100 may operate with may be stored in storage system 170 and/or data storage (151, 161) for access by computer system 200 during the auto-discovery and auto-configuration process. For example, computer system 200 (e.g., server 150) may through network 180 and/or communications interface 212 access information in a data base or other data store the includes a library of user devices and their attributes, OS's, UI's, GUI's, communications protocols, and the like, and use the information to effectuate the auto-discovery and auto-configuration process.

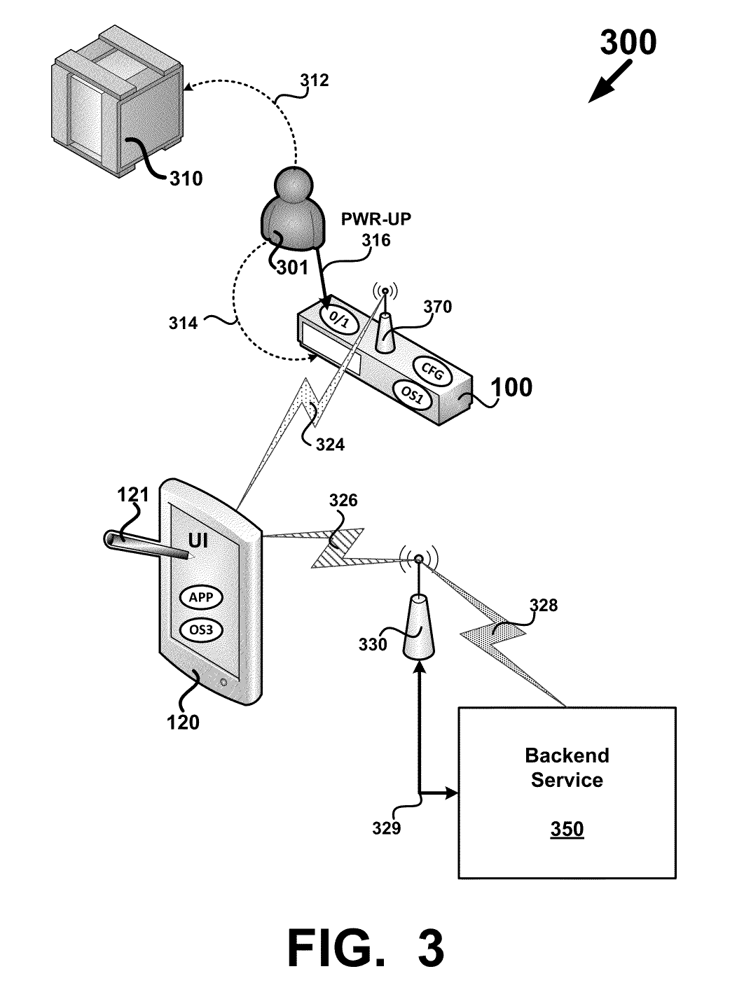

FIG. 3 depicts one example of a system 300 for auto-discovery and auto-configuration. System 300 includes a media device 100, that for purposes of explanation, may be assumed to be a brand new media device that is in its retail packaging (e.g., new in box) or other packaging, denoted as box 310, a user device 120, and a backend service 350. User device 120 may include a user interface (UI) for displaying information and receiving input from user 301 (e.g., using stylus 121). Backend service 350 may be in communication (e.g., wired or wireless) with a processor and/or a storage system (not shown). A user 301 (e.g., a purchaser of the media device 100) may extract (e.g., un-box) the media device 100 from box 310 as denoted by dashed arrow 312. The user 301 may then position the media device on a suitable structure or surface such as a table, desk, counter, or the like, for example, as denoted by dashed arrow 314. User 301 may then power up the media device 100 for the very first time (e.g., an initial powering up) by actuating 316 a power button, switch, icon, or the like on media device 100, which is denoted here as “0/1”. At initial power up (PWR-UP) 316, media device 100 uses one or more transceivers in its RF system (e.g., radio transceivers) to detect RF signatures from user devices, such as user device 120. In some examples, the media device 100 may need to be connected with a power source (e.g., AC or DC) prior to the powering up 316. In other examples, media device 100 may include a rechargeable power source that may need to be charged up prior to the powering up 316.

As one example, a RF signature may be a Bluetooth (BT) signature such as the type transmitted by a BT equipped user device that is in BT pairing mode to discover another BT device to pair with. Here, media device 100 at initial power up may be placed in BT pairing mode and the RF system of media device 100 may use a BT radio coupled with antenna 370 to listen for a BT RF signature from a user device, such as user device 120. Wireless communications between the wireless communications links of the user device 120 and media device 100 are denoted as 324. The RF system of media device 100 may include a plurality of different RF transceivers (e.g., radios) including but not limited to BT, WiFi, Ad Hoc (AH), and cellular (e.g., 3G, 4G). In some examples, media device 100 includes no fewer than two radio transceivers. The AH radio may be specifically configured for wireless communications between the media device 100 and other similarly equipped media devices and may be operative as a proprietary communications link between media devices. User device 120 may also include a plurality of different RF transceivers (e.g., radios) such a BT radio, a wireless (WiFi) radio, a cellular radio, just to name a few. The user device 120, the media device 100, or both may be configured for near field communications (NFC) using their respective RF systems.

After a successful BT paring of the media device 100 and user device 120, the BT radios of each device may be used to communicate information necessary to automatically configure the media device 100, the user device 120, or both. Media device 100 may include information for a location (e.g., address) for a backend service 350 specifically designed to communicate with the media device 100, the user device 120, or both to effectuate the automatic configuration. Information in media device 100 may include an Internet address for a web site (e.g., a uniform resource locator (URL)) that is communicated 324 to the user device 120. User device 120 may include a display, screen, touch screen or the like for displaying information and images and/or accepting input from user 301. Here, a user interface (UI) is displayed on user device 120 and the information from media device 100 may be presented on the UI. As one example, media device 100 may wirelessly communicate 324 a URL to user device 120 and user device 120 may use the URL to navigate to a web page, a location on the Internet, in the cloud, or other where data may be transmitted to or received from to facilitate the auto-configuration of the media device 100, user device 120, or both. Although communications between the user device 120 and media device 100 may be wireless, in some examples, the user device 120 may also be configured for wired communication (e.g., Ethernet, LAN) and may use its wired communications link to transmit and receive data as part of the auto-detection and auto-configuration process.

Communications between the backend service 350 and the user device 120 and/or media device 100 may be wireless 328 and/or wired 329. Wired 329 may be via a router, switch, Ethernet, fiber, LAN, or other type of wired data connection. Wireless 328 may be from a device 330 such as wireless router, cellular network, WiFi, WiMAX, or other type of wireless communication. As will be described below, backend service 350 may include and/or be connected with a processor and a storage system.

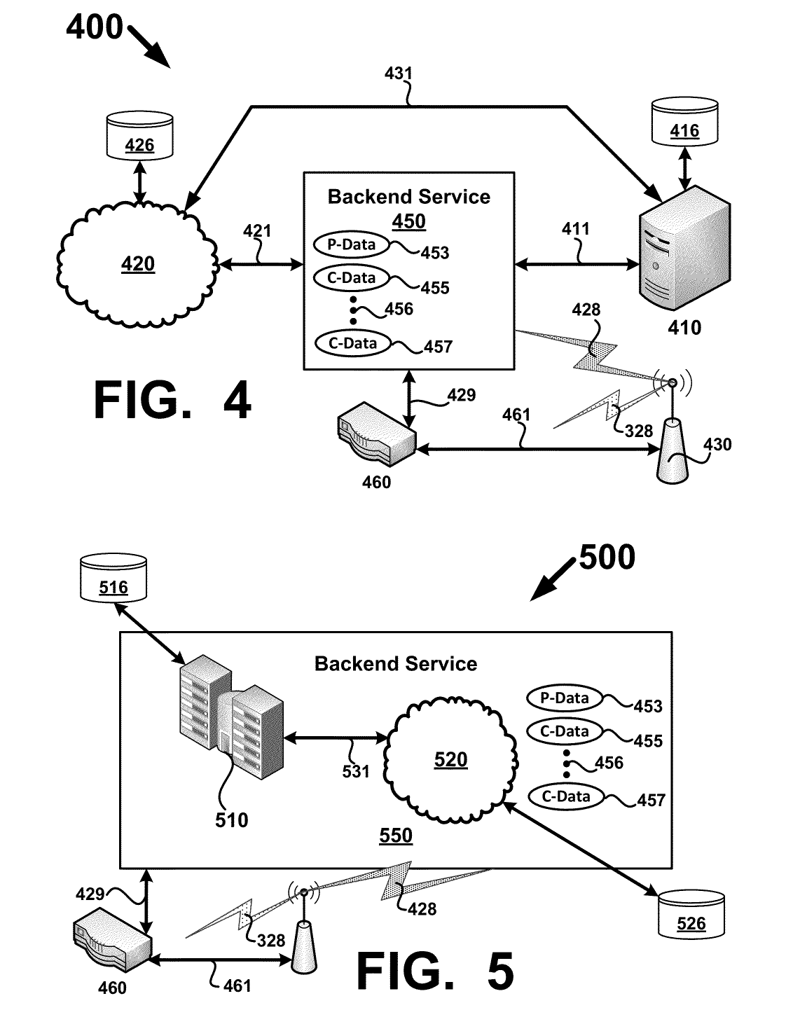

FIG. 4 depicts one example 400 of a backend service 450. Backend service 450 may be coupled 411 with one or more external processors 410 (e.g., a server, PC, compute engine, etc.) and coupled 421 with an external storage system 420 (e.g., cloud storage, server farm, RAID, HDD, SDD, etc.). Processor 410 and/or storage system 420 may optionally be coupled with a dedicated data storage unit denoted as 416 and 426, respectively. Backend service 450 is coupled (411, 421) with processor 410 and storage system 420 via a wired connection, wireless connection, or both. Processor 420 and storage system 420 may optionally be coupled with each other via a connection 431 that may be a wired connection, wireless connection, or both. Backend service 450 may be coupled with media device 100 and/or user device 120 via a wireless connection 328, a wired connection 429, or both. For example, a router 460 may implement an Ethernet connection with backend service 450. As another example, a wireless network 430 may wirelessly connect 428 with backend service 450. Wireless network 430 may wirelessly connect 328 with other wireless devices, such as media device 100 and/or user device 120 and connect wirelessly 428 and/or wired 429 with backend service 450. Wireless network 430 may be a WiFi router, a cellular network, or some other type of wireless network.

Backend service 450 may be configured to receive (e.g., via 460 or 430) prerequisite configuration data (P-Data) 453 from media device 100 and/or user device 120 and may use processor 410 to process the P-Data 453 to generate configuration data (C-Data) 455. C-Data 455 may be configured for downloading to the media device 100, the user device 420, or both. Furthermore, there may be more than one C-Data generated by backend service 450 as denoted by 456 and that C-Data may be generated in one or more stages. For example, backend service 450 may generate a plurality of C-Data's denoted as 455 and 457, but there may be more than C-Data's than the two depicted in FIG. 4. C-Data and P-Data may be embodied in any form that may be processed or otherwise acted on by the device it is intended for, including but not limited to a file, a data structure, a look-up table, a hash table, a configuration file, an application file, an executable file, just to name a few. C-Data may include both data and program instructions configured to execute on a processor in the device the C-Data is intended for (e.g., media device 100 or user device 120). A used herein, the term C-Data may also be referred to as a configuration (CFG) or an application (APP).

FIG. 5 depicts another example 500 of a backend service 550. Here, backend service 550 comprises one or more processors 510 and a storage system 520. Storage system 520 and processor 510 may optionally be coupled 531 with each other. Processor 510 and/or storage system 520 may optionally be coupled with a dedicated data storage unit denoted as 516 and 526, respectively.

In FIGS. 4 and 5, backend services (450, 550) may use their respective processors (410, 510) to execute program instructions fixed in a non-transitory computer readable medium to process the P-Data 453, access (e.g., for read or write) the storage systems (420, 520) and/or dedicated storage units (416, 426, 516, 526) to retrieve and store data for generating the C-Data 455. In some examples, the P-Data 453 is obtained by a query of the user device 120, with the query being done by the media device 100, the backend service (450, 550), or both. After the media device 100 and user device 120 have established wireless communications with each other the following examples may occur: (a) the media device 100 may query the user device 120 to obtain the information needed for the P-Data 453 and then the P-Data 453 may be transmitted to the backend service (450, 550), by the user device 120 (e.g., wired or wirelessly), the media device (e.g., wirelessly), or both; (b) the backend service (450, 550) may query the user device 120 to obtain the information needed for the P-Data 453; or (c) the user device 120 queries itself to obtain the information needed for the P-Data 453 and then the P-Data 453 is transmitted to the backend service (450, 550). In example (c), a command from the media device 100 or the backend service (450, 550) may cause the user device 120 to query itself. In example (b), the media device 100 may include an address (e.g., a URL, FTP address, etc.) for the backend service (450, 550) and the user device 120 may use that address to connect (wired or wirelessly) with the backend service (450, 550) so that the backend service (450, 550) may gain access to the user device 120 to perform the query for P-Data 453.

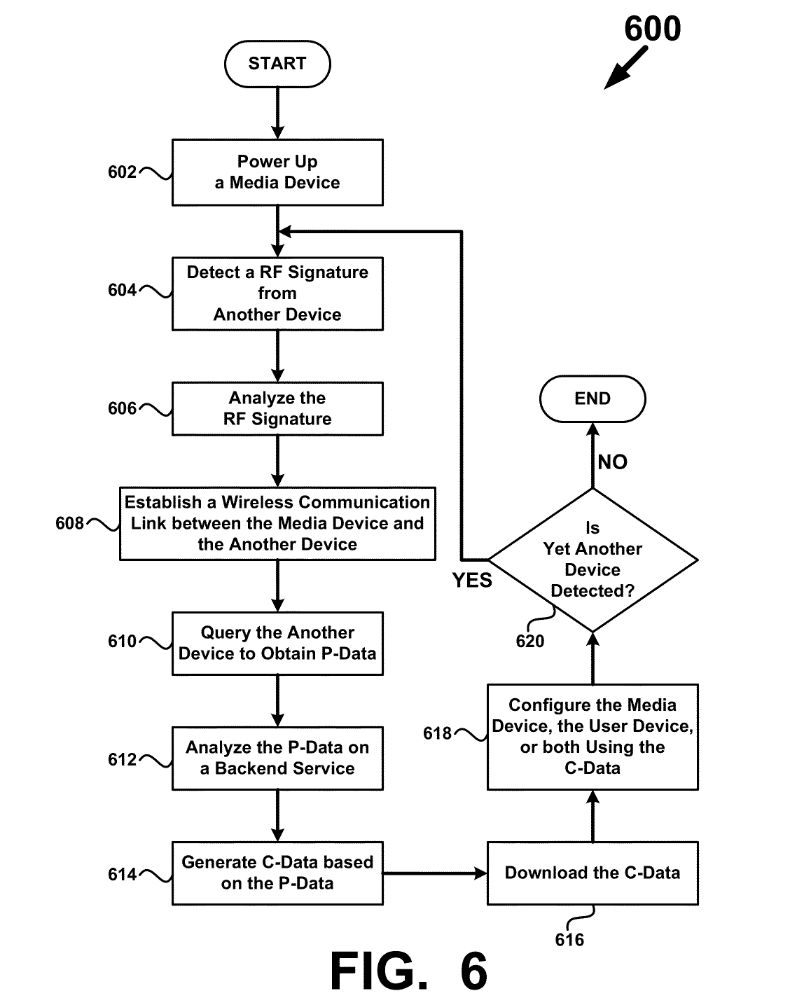

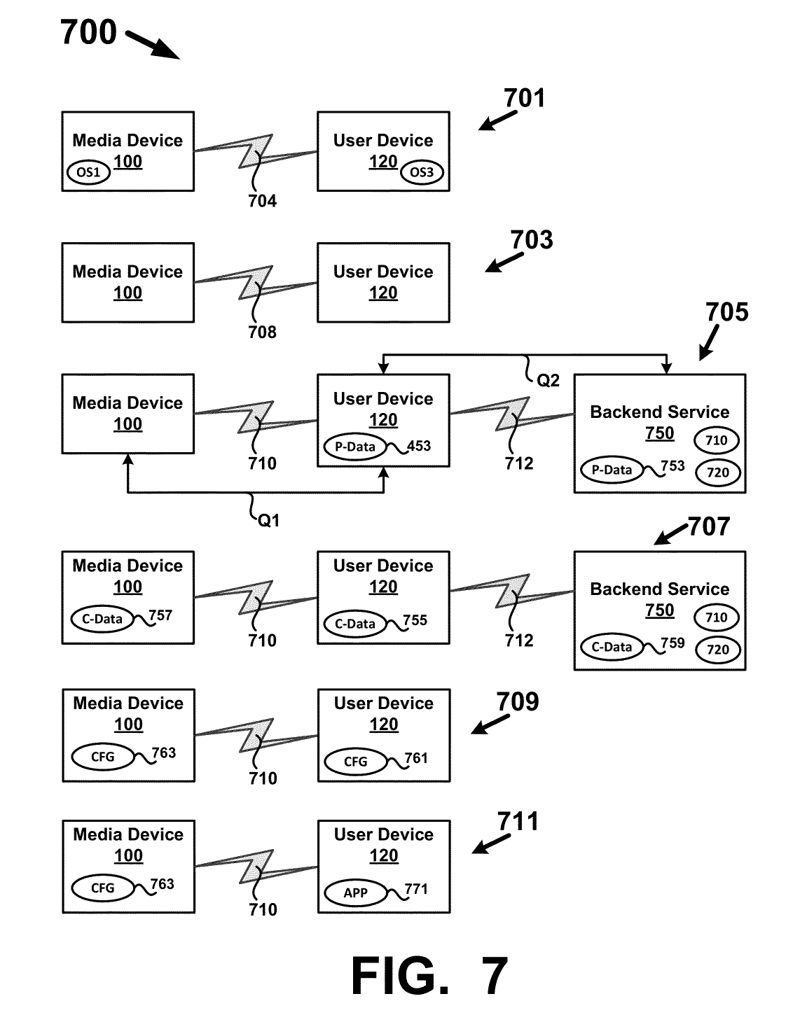

Attention is now directed to FIG. 6, where one example of a flow diagram 600 for auto-detection and auto-configuration is depicted. At a stage 602 a media device 100 may be powered up. The powering up at the stage 602 may be the initial power up of the media device 100 as described above (e.g., the out-of-the-box power up of FIG. 3). At a stage 604, the media device 100 uses its RF systems (e.g., one or more radio transceivers) to detect a RF signature from a radio transceiver of another device (e.g., user device 120). The another device may have a plurality of radio transceivers and some or all of those transceivers may be emitting a RF signature at the time the media device 100 is doing the detecting at the stage 604. At a stage 606 the RF signature or RF signatures are analyzed by the media device 100 to determine whether or not any of the RF signatures detected are protocol compatible with the protocols used by the radio transceiver(s) of the RF system of the media device 100. At a stage 608 a wireless communications link is established between the another device and the media device 100. The wireless communications link is established using the radio transceiver in the RF system that is protocol compatible with the RF signature detected from the another device. As one example, if the RF signature detected is a WiFi signal (e.g., any of the IEEE 802 wireless protocols) then the RF system will establish the wireless communications link using its WiFi radio to connect with a WiFi radio in the another device. As a second example, if the RF signature detected is Bluetooth® (BT), then the RF system will establish the wireless communications link using its BT radio to connect with a BT radio in the another device. Further, if the RF signature detected is BT, then the stage 608 may include the necessary BT paring between the media device 100 and the another device. At a stage 610, the another device is queried to obtain prerequisite data (e.g., P-Data 453) that will subsequently be used to generate configuration data for the media device 100, the another device (e.g., user device 120), or both as was described above.

At a stage 612, the P-Data is analyzed on a backend service (e.g., 350, 450, 550) to generate the P-Data based on the type of device the another device is (e.g., tablet, pad, smartphone, cell phone, PDA, laptop computer, touch screen computer, portable device, music player, video player, gaming device, desktop computer, etc.). As described above the backend service may use processors and storage systems to analyze the P-Data. At a stage 614, configuration data (e.g., C-Data 455, 457) is generated by the backend service based on the P-Data. At a stage 616 the C-Data is downloaded (e.g., is transmitted wired or wirelessly) to the media device 100, the another device, or both. At a stage 618 the media device 100, the another device, or both are configured using the C-Data.

At a stage 620 a determination may be made as to whether or not yet another device has its RF signature detected by the media device 100 at the stage 602 or other stage of flow 600. If no other RF signatures are detected, then a NO branch may be taken and the flow 600 may terminate. On the other hand, if another RF signature is detected from yet another device, then a YES branch may be taken and the flow 600 may cycle back to a previous stage, such as the stage 604, for example. As one example, at the stage 604 a plurality of RF signatures may have been detected by the RF system of media device 100 and the media device 100 may be configured to select one of the plurality of RF signatures at the stage 604 and the flow 600 may be applied to the selected RF signature. At the stage 620, the YES branch may be taken to the stage 604 or other stage, to apply the flow 600 to the next one of the plurality of RF signatures that was detected.

As another example, the media device 100 may be powered up any number of times after its initial out-of-the-box power up (e.g., in FIG. 3). During one of the aforementioned power up cycles, the media device 100 may detect the RF signature of a device it is not already configured to operate with. To that end, flow 600 may begin at any of the stages 602-620 to obtain the P-Data from the device and to generate the C-Data as described above.

As yet another example, anytime during the flow 600, media device 100 may detect a new RF signature from a device and may queue that device for later processing using the flow 600. There may be several scenarios which result in the media device 100 processing a plurality of RF signatures from different devices it detects at approximately the same time or at different time. For example, user 320 may first activate a pad and the RF signature from the pad is detected by media device 100 and flow 600 is applied to the pad. Later, during or after flow 600, the user 320 may activate a smartphone and media device 100 detects the RF signature of the smartphone and applies flow 600 to the smartphone. In other examples, a user device may be activated (e.g., turned on/powered up) but their radios may not be turned on or are otherwise not detectable by media device 100 (e.g., out of RF reception range of the media device 100).

At the stage 606, media device 100 may detect multiple RF signatures from the another device (e.g., user device 120), such as a BT signature and a WiFi signature, for example. Media device 100 may be configured to select a specific one of the multiple RF signatures to proceed with at the stage 608, such as the BT signature or the WiFi signature. In some examples, the media device 100 may upon detection of the multiple RF signatures, decide to establish the wireless communications link at the stage 608 using one of the multiple RF signatures and then later during the stage 608 or after the stage 608, switch to another one of the multiple RF signatures to establish the wireless communications link with. For example, media device 100 may use BT at the stage 608 and then later switch to WiFi. The media device 100 may use BT at the stage 608 to wirelessly communicate with the another device to obtain the name of the wireless network and the wireless network password (if needed) that the another device is using for WiFi communications. Then after gaining access to the same WiFi network that the another device is using, the media device 100 may then use the WiFi network for any wireless communications needed in the flow 600 or for other purposes. The media device 100 may use the WiFi network to communicate with the backend service (350, 450, 550) for transmission of the P-Data and receiving of the C-Data, for example.

The stages of flow 600 allow for a user (e.g., user 301) to purchase a new media device 100, un-box the media device 100, power up the media device 100 in the presence of one or more of the user's devices (e.g., user device 120 or others) and without having to do more, have the media device 100 automatically detect the user's devices based on their RF signatures and then automatically configure itself and/or the user's devices without any intervention or extra effort on part of the user 301. Essentially, getting the media device 100 to interface with and operate with the user's devices is a seamless experience on part of the user 301. The P-Data that is obtained from the query process in conjunction with the processing and storage systems of the backend service operate to unburden the user 301 from having to intervene in the configuration process due to differences in types and operating systems of his/her various user devices. Furthermore, long after the media device 100 has been powered up for the first time, the user 301 may subsequently introduce other user devices that may be auto-detected and auto-configured by the media device 100 in conjunction with the backend service.

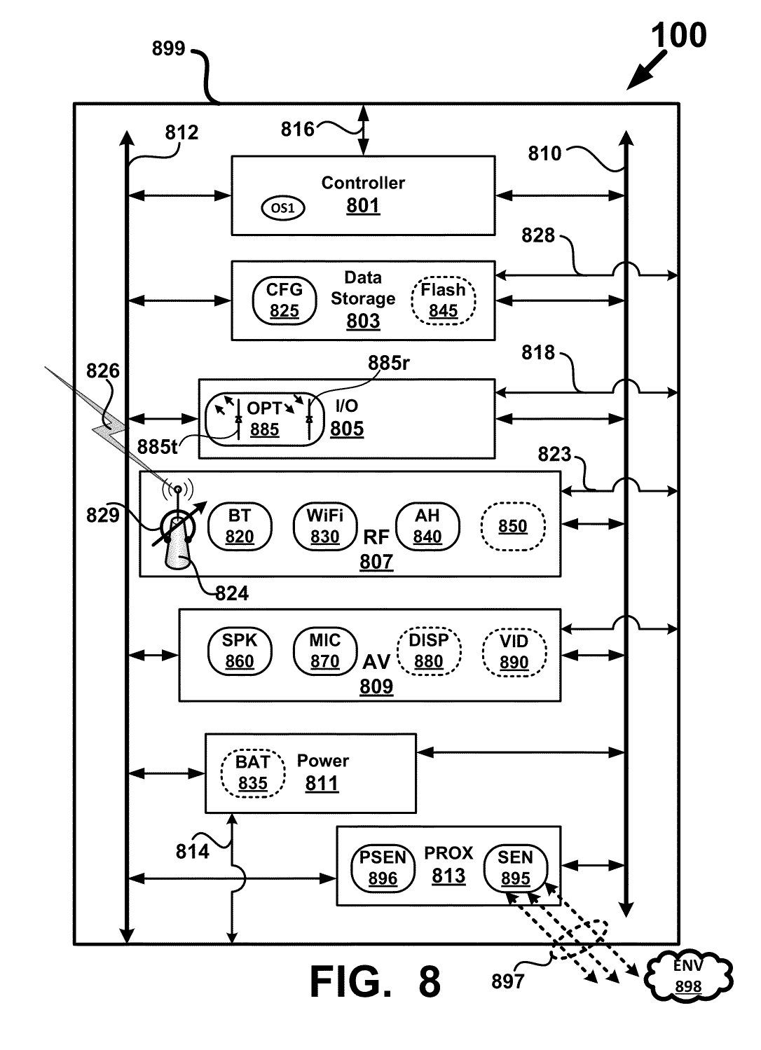

FIG. 7 depicts a block diagram 700 of an example of an auto-detect and auto-configuration sequence for a media device 100 and user device 120. Here at sequence 701, media device 100 has been powered up (e.g., new out of-the-box) and has detected 704 the RF signature of user device 120. At sequence 703, the media device 100 has analyzed the RF signature and has established a wireless communications link 708 with the user device 120. At sequence 705, the media device 100 and user device 120 are in wireless communications 710 with each other and the user device 120 and backend service 750 are in communications 712 with each other (wired or wireless). The query process to obtain P-Data 453 from the user device 120 is in progress with either the media device 100 querying Q1 the user device 120, the backend service 750 querying Q2 the user device 120, or both. During sequence 705 the P-Data 453 obtained from user device 120 is transmitted to the backend service 750 and is denoted as P-Data 753. During sequence 705 the backend service 750 may use processor 710 and storage system 720 in the processing of the P-Data 753. At sequence 707 the backend service 750 has processed the P-Data 753 to generate C-Data 759 which is downloaded to the media device 100 as C-Data 757, the user device 120 (C-Data 755), or both. At sequence 709, the media device 100, the user device 120 or both are configured as denoted by CFG 763 and CFG 761. At a sequence 711, the C-Data downloaded to user device 120 may be an application APP 771 specifically configured to allow interoperation, control, command, and communication between the media device 100 and the user device 120. APP 771 may be downloaded from the backend service 750 or from some other location such as an app store, a web site, or a cellular provider, for example. In some examples, APP 771 may supplant or replace CFG 761. CFG 763 and/or C-Data 757 may comprise information including but not limited to wireless network names and password, device specific data such as the OS used by the user device 120, locations of media accessed by the user device 120, locations of playlists accessed by the user device 120, data storage systems of the user device 120, memory locations where files and/or data are located in the user device 120, URL's or other types of addresses for web sites or the like that are accessed by the user device 120 for services such as social networks, streaming media services, Internet radio, downloads of media, files, or images, etc.

In diagram 700, the auto-detection and auto-configuration sequences 701-711 occur in a seamless manner even though there may be major or minor differences in hardware and software between the media device 100 and user device 120. For example, an OS1 of the media device 100 may be totally different that an OS3 of the user device 120. Furthermore, the processor types and system architecture of the media device 100 and the user device 120 may be totally different. Those differences in hardware, software and architecture, and other differences may be overcome by using the aforementioned wireless communication links and the backend service 750 to divine information about the user device (e.g., via the query and P-Data) necessary to configure media device 100, the user device 120, or both to communicate and cooperate with each other using the C-Data.

FIG. 8 depicts a block diagram of one example of a media device 100. Media device 100 may have systems including but not limited to a controller 801, a data storage (DS) system 803, a input/output (I/O) system 805, a radio frequency (RF) system 807, an audio/video (NV) system 809, a power system 811, and a proximity sensing (PROX) system 813. A bus 810 enables electrical communication between the controller 801, DS system 803, I/O system 805, RF system 807, AV system 809, power system 811, and PROX system 813. Power bus 812 supplies electrical power from power system 811 to the controller 801, DS system 803, I/O system 805, RF system 807, AV system 809, and PROX system 813.

Power system 811 may include a power source internal to the media device 100 such as a battery (e.g., AAA or AA batteries) or a rechargeable battery (e.g., such as a lithium ion or nickel metal hydride type battery, etc.) denoted as BAT 835. Power system 811 may be electrically coupled with a port 814 for connecting an external power source (not shown) such as a power supply that connects with an external AC or DC power source. Examples include but are not limited to a wall wart type of power supply that converts AC power to DC power or AC power to AC power at a different voltage level. In other examples, port 814 may be a connector (e.g., an IEC connector) for a power cord that plugs into an AC outlet or other type of connecter, such as a universal serial bus (USB) connector. Power system 811 provides DC power for the various systems of media device 100. Power system 811 may convert AC or DC power into a form usable by the various systems of media device 100. Power system 811 may provide the same or different voltages to the various systems of media device 100. In applications where a rechargeable battery is used for BAT 835, the external power source may be used to power the power system 811, recharge BAT 835, or both. Further, power system 811 on its own or under control or controller 801 may be configured for power management to reduce power consumption of media device 100, by for example, reducing or disconnecting power from one or more of the systems in media device 100 when those systems are not in use or are placed in a standby or idle mode. Power system 811 may also be configured to monitor power usage of the various systems in media device 100 and to report that usage to other systems in media device 100 and/or to other devices (e.g., including other media devices 100 and user devices 120) using one or more of the I/O system 805, RF system 807, and AV system 809, for example. Operation and control of the various functions of power system 811 may be externally controlled by other devices (e.g., including other media devices 100).

Controller 801 controls operation of media device 100 and may include a non-transitory computer readable medium, such as executable program code to enable control and operation of the various systems of media device 100. For example, operating system OS1 may be stored in Flash memory 845 of DS 803 and be used (e.g., loaded or booted up) by controller 801 to control operation of the media device 100. DS 803 may be used to store executable code used by controller 801 in one or more data storage mediums such as ROM, RAM, SRAM, RAM, SSD, Flash, etc., for example. Controller 801 may include but is not limited to one or more of a microprocessor (μP), a microcontroller (μP), a digital signal processor (DSP), a baseband processor, an application specific integrated circuit (ASIC), a field programmable gate array (FPGA), just to name a few. Processors used for controller 801 may include a single core or multiple cores (e.g., dual core, quad core, etc.). Port 816 may be used to electrically couple controller 801 to an external device (not shown).

DS system 803 may include but is not limited to non-volatile memory (e.g., Flash memory), SRAM, DRAM, ROM, SSD, just to name a few. In that the media device 100 in some applications is designed to be compact, portable, or to have a small size footprint, memory in DS 803 will typically be solid state memory (e.g., no moving or rotating components); however, in some application a hard disk drive (HDD) or hybrid HDD may be used for all or some of the memory in DS 803. In some examples, DS 803 may be electrically coupled with a port 828 for connecting an external memory source (e.g., USB Flash drive, SD, SDHC, SDXC, microSD, Memory Stick, CF, SSD, etc.). Port 828 may be a USB or mini USB port for a Flash drive or a card slot for a Flash memory card. In some examples as will be explained in greater detail below, DS 803 includes data storage for configuration data, denoted as CFG 825 (e.g., C-Data), used by controller 801 to control operation of media device 100 and its various systems. DS 803 may include memory designated for use by other systems in media device 100 (e.g., MAC addresses for WiFi 830, network passwords, data for settings and parameters for NV 809, and other data for operation and/or control of media device 100, etc.). DS 803 may also store data used as an operating system (OS) for controller 801 (e.g., OS1). If controller 801 includes a DSP, then DS 803 may store data, algorithms, program code, an OS, etc. for use by the DSP, for example. In some examples, one or more systems in media device 100 may include their own data storage systems.

I/O system 805 may be used to control input and output operations between the various systems of media device 100 via bus 810 and between systems external to media device 100 via port 818. Port 818 may be a connector (e.g., USB, HDMI, Ethernet, fiber optic, Toslink, Firewire, IEEE 1394, or other) or a hard wired (e.g., captive) connection that facilitates coupling I/O system 805 with external systems. In some examples port 818 may include one or more switches, buttons, or the like, used to control functions of the media device 100 such as a power switch, a standby power mode switch, a button for wireless pairing, an audio muting button, an audio volume control, an audio mute button, a button for connecting/disconnecting from a WiFi network, an infrared (IR) transceiver, just to name a few. I/O system 805 may also control indicator lights, audible signals, or the like (not shown) that give status information about the media device 100, such as a light to indicate the media device 100 is powered up, a light to indicate the media device 100 is in wireless communication (e.g., WiFi, Bluetooth®, WiMAX, cellular, etc.), a light to indicate the media device 100 is Bluetooth® paired, in Bluetooth® pairing mode, Bluetooth® communication is enabled, a light to indicate the audio and/or microphone is muted, just to name a few. Audible signals may be generated by the I/O system 805 or via the AV system 807 to indicate status, etc. of the media device 100. Audible signals may be used to announce Bluetooth® status, powering up or down the media device 100, muting the audio or microphone, an incoming phone call, a new message such as a text, email, or SMS, just to name a few. In some examples, I/O system 805 may use optical technology to wirelessly communicate with other media devices 100 or other devices. Examples include but are not limited to infrared (IR) transmitters, receivers, transceivers, an IR LED, and an IR detector, just to name a few. I/O system 805 may include an optical transceiver OPT 885 that includes an optical transmitter 885t (e.g., an IR LED) and an optical receiver 885r (e.g., a photo diode). OPT 885 may include the circuitry necessary to drive the optical transmitter 885t with encoded signals and to receive and decode signals received by the optical receiver 885r. Bus 810 may be used to communicate signals to and from OPT 885. OPT 885 may be used to transmit and receive IR commands consistent with those used by infrared remote controls used to control AV equipment, televisions, computers, and other types of systems and consumer electronics devices. The IR commands may be used to control and configure the media device 100, or the media device 100 may use the IR commands to configure/re-configure and control other media devices or other user devices, for example.

RF system 807 includes at least one RF antenna 824 that is electrically coupled with a plurality of radios (e.g., RF transceivers) including but not limited to a Bluetooth® (BT) transceiver 820, a WiFi transceiver 830 (e.g., for wireless communications over a WiFi and/or WiMAX network), and a proprietary Ad Hoc (AH) transceiver 840 pre-configured (e.g., at the factory) to wirelessly communicate with a proprietary Ad Hoc wireless network (AH-WiFi) (not shown). AH 840 and AH-WiFi are configured to allow wireless communications between similarly configured media devices (e.g., an ecosystem comprised of a plurality of similarly configured media devices) as will be explained in greater detail below. RF system 807 may include more or fewer radios than depicted in FIG. 8 and the number and type of radios will be application dependent. Furthermore, radios in RF system 807 need not be transceivers, RF system 807 may include radios that transmit only or receive only, for example. Optionally, RF system 807 may include a radio 850 configured for RF communications using a proprietary format, frequency band, or other existent now or to be implemented in the future. Radio 850 may be used for cellular communications (e.g., 3G, 4G, or other), for example. Antenna 824 may be configured to be a de-tunable antenna such that it may be de-tuned 829 over a wide range of RF frequencies including but not limited to licensed bands, unlicensed bands, WiFi, WiMAX, cellular bands, Bluetooth®, from about 2.0 GHz to about 6.0 GHz range, and broadband, just to name a few. As will be discussed below, PROX system 813 may use the de-tuning 829 capabilities of antenna 824 to sense proximity of the user, other people, the relative locations of other media devices 100, just to name a few. Radio 850 (e.g., a transceiver) or other transceiver in RF 807, may be used in conjunction with the de-tuning capabilities of antenna 824 to sense proximity, to detect and or spatially locate other RF sources such as those from other media devices 100, devices of a user, just to name a few. RF system 807 may include a port 823 configured to connect the RF system 807 with an external component or system, such as an external RF antenna, for example. The transceivers depicted in FIG. 8 are non-limiting examples of the type of transceivers that may be included in RF system 807. RF system 807 may include a first transceiver configured to wirelessly communicate using a first protocol, a second transceiver configured to wirelessly communicate using a second protocol, a third transceiver configured to wirelessly communicate using a third protocol, and so on. One of the transceivers in RF system 807 may be configured for short range RF communications, such as within a range from about 1 meter to about 15 meters, or less, for example. Another one of the transceivers in RF system 807 may be configured for long range RF communications, such any range up to about 50 meters or more, for example. Short range RF may include Bluetooth®; whereas, long range RF may include WiFi, WiMAX, cellular, and Ad Hoc wireless, for example.

AV system 809 includes at least one audio transducer, such as a loud speaker 860, a microphone 870, or both. AV system 809 further includes circuitry such as amplifiers, preamplifiers, or the like as necessary to drive or process signals to/from the audio transducers. Optionally, AV system 809 may include a display (DISP) 880, video device (VID) 890 (e.g., an image capture device or a web CAM, etc.), or both. DISP 880 may be a display and/or touch screen (e.g., a LCD, OLED, or flat panel display) for displaying video media, information relating to operation of media device 100, content available to or operated on by the media device 100, playlists for media, date and/or time of day, alpha-numeric text and characters, caller ID, file/directory information, a GUI, just to name a few. A port 822 may be used to electrically couple AV system 809 with an external device and/or external signals. Port 822 may be a USB, HDMI, Firewire/IEEE-1394, 3.5 mm audio jack, or other. For example, port 822 may be a 3.5 mm audio jack for connecting an external speaker, headphones, earphones, etc. for listening to audio content being processed by media device 100. As another example, port 822 may be a 3.5 mm audio jack for connecting an external microphone or the audio output from an external device. In some examples, SPK 860 may include but is not limited to one or more active or passive audio transducers such as woofers, concentric drivers, tweeters, super tweeters, midrange drivers, sub-woofers, passive radiators, just to name a few. MIC 870 may include one or more microphones and the one or more microphones may have any polar pattern suitable for the intended application including but not limited to omni-directional, directional, bi-directional, uni-directional, bi-polar, uni-polar, any variety of cardioid pattern, and shotgun, for example. MIC 870 may be configured for mono, stereo, or other. MIC 870 may be configured to be responsive (e.g., generate an electrical signal in response to sound) to any frequency range including but not limited to ultrasonic, infrasonic, from about 20 Hz to about 20 kHz, and any range within or outside of human hearing. In some applications, the audio transducer of AV system 809 may serve dual roles as both a speaker and a microphone.

Circuitry in AV system 809 may include but is not limited to a digital-to-analog converter (DAC) and algorithms for decoding and playback of media files such as MP3, FLAG, AIFF, ALAC, WAV, MPEG, QuickTime, AVI, compressed media files, uncompressed media files, and lossless media files, just to name a few, for example. A DAC may be used by AV system 809 to decode wireless data from a user device or from any of the radios in RF system 807. AV system 809 may also include an analog-to-digital converter (ADC) for converting analog signals, from MIC 870 for example, into digital signals for processing by one or more system in media device 100.

Media device 100 may be used for a variety of applications including but not limited to wirelessly communicating with other wireless devices, other media devices 100, wireless networks, and the like for playback of media (e.g., streaming content), such as audio, for example. The actual source for the media need not be located on a user's device (e.g., smart phone, MP3 player, iPod, iPhone, iPad, Android, laptop, PC, etc.). For example, media files to be played back on media device 100 may be located on the Internet, a web site, or in the cloud, and media device 100 may access (e.g., over a WiFi network via WiFi 830) the files, process data in the files, and initiate playback of the media files. Media device 100 may access or store in its memory a playlist or favorites list and playback content listed in those lists. In some applications, media device 100 will store content (e.g., files) to be played back on the media device 100 or on another media device 100.

Media device 100 may include a housing, a chassis, an enclosure or the like, denoted in FIG. 8 as 899. The actual shape, configuration, dimensions, materials, features, design, ornamentation, aesthetics, and the like of housing 899 will be application dependent and a matter of design choice. Therefore, housing 899 need not have the rectangular form depicted in FIG. 8 or the shape, configuration etc., depicted in the Drawings of the present application. Nothing precludes housing 899 from comprising one or more structural elements, that is, the housing 899 may be comprised of several housings that form media device 100. Housing 899 may be configured to be worn, mounted, or otherwise connected to or carried by a human being. For example, housing 899 may be configured as a wristband, an earpiece, a headband, a headphone, a headset, an earphone, a hand held device, a portable device, a desktop device, just to name a few.

In other examples, housing 899 may be configured as speaker, a subwoofer, a conference call speaker, an intercom, a media playback device, just to name a few. If configured as a speaker, then the housing 899 may be configured as a variety of speaker types including but not limited to a left channel speaker, a right channel speaker, a center channel speaker, a left rear channel speaker, a right rear channel speaker, a subwoofer, a left channel surround speaker, a right channel surround speaker, a left channel height speaker, a right channel height speaker, any speaker in a 2.1, 3.1, 5.1, 7.1, 9.1 or other surround sound format including those having two or more subwoofers or having two or more center channels, for example. In other examples, housing 899 may be configured to include a display (e.g., DISP 880) for viewing video, serving as a touch screen interface for a user, providing an interface for a GUI, for example.

PROX system 813 may include one or more sensors denoted as SEN 895 that are configured to sense 897 an environment 898 external to the housing 899 of media device 100. Using SEN 895 and/or other systems in media device 100 (e.g., antenna 824, SPK 860, MIC 870, etc.), PROX system 813 senses 897 an environment 898 that is external to the media device 100 (e.g., external to housing 899). PROX system 813 may be used to sense one or more of proximity of the user or other persons to the media device 100 or other media devices 100. PROX system 813 may use a variety of sensor technologies for SEN 895 including but not limited to ultrasound, infrared (IR), passive infrared (PIR), optical, acoustic, vibration, light, ambient light sensor (ALS), IR proximity sensors, LED emitters and detectors, RGB LED's, RF, temperature (e.g., non-contact temperature sensors), capacitive, capacitive touch, inductive, just to name a few. PROX system 813 may be configured to sense location of users or other persons, user devices, and other media devices 100, without limitation. Output signals from PROX system 813 may be used to configure media device 100 or other media devices 100, to re-configure and/or re-purpose media device 100 or other media devices 100 (e.g., change a role the media device 100 plays for the user, based on a user profile or configuration data), just to name a few. A plurality of media devices 100 in an eco-system of media devices 100 may collectively use their respective PROX system 813 and/or other systems (e.g., RF 807, de-tunable antenna 824, AV 809, etc.) to accomplish tasks including but not limited to changing configuration, re-configuring one or more media devices, implement user specified configurations and/or profiles, insertion and/or removal of one or more media devices in an eco-system, just to name a few.

In other examples, PROX 813 may include one or more proximity detection islands PSEN 896. PSEN 896 may be positioned at one or more locations on chassis 899 and configured to sense an approach of a user or other person towards the media device 100 or to sense motion or gestures of a user or other person by a portion of the body such as a hand for example. PSEN 896 may be used in conjunction with or in place of one or more of SEN 895, OPT 885, SPK 860, MIC 870, RF 807 and/or de-tunable 829 antenna 824 to sense proximity and/or presence in an environment surrounding the media device 100, for example. PSEN 896 may be configured to take or cause an action to occur upon detection of an event (e.g., an approach or gesture by a user or other) such as emitting light (e.g., via an LED), generating a sound or announcement (e.g., via SPK 860), causing a vibration (e.g., via SPK 860 or a vibration motor), display information (e.g., via DISP 880), trigger haptic feedback, for example. In some examples, PSEN 896 may be included in I/O 805 instead of PROX 813 or be shared between one or more systems of media device 100. In other examples, components, circuitry, and functionality of PSEN 896 may vary among a plurality of PSEN 896 sensors in media device 100 such that all PSEN 896 are not identical. PSEN 896 may be referred to as one or more proximity detection islands (e.g., I1-I4).

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

1. A system for auto-discovery and auto-configuration, comprising:
a backend service including a first communication link;
a user device including a second communication link that is in communication with the first communication link; and
a media device including a third communication link,
the media device configured, at power up, to use the third communication link to wirelessly discover the second communication link and to establish a wireless connection between the second and third communications links, and
the backend service configured to query the user device for prerequisite configuration data (P-Data) and use the P-Data to retrieve device specific configuration data (C-Data) and download the C-Data to the user device, the media device, or both.

2. The system of claim 1, wherein a processor in communication with the backend service controls the query, retrieve, and download by executing program instructions fixed in a non-transitory computer readable medium.

3. The system of claim 1, wherein the C-Data comprises an application (APP) stored in a non-transitory computer readable medium in the user device, the APP specifically configured to be executed on the user device and operative to configure the media device.

4. The system of claim 3, wherein the APP is configured to cause configuration data (CFG) to be wirelessly downloaded to a non-transitory computer readable medium in the media device.

5. The system of claim 4, wherein the CFG is operative to enable functions including control, command, and communication between the user device and the media device, and operative to wirelessly connect the media device with at least one wireless network.

6. The system of claim 3, wherein the CFG is wirelessly downloaded from the backend service using the first and third communications links.

7. The system of claim 3, wherein the CFG is wirelessly downloaded from the user device using the second and third communications links.

8. The system of claim 1, wherein the second and third communications links both comprise at least two different types of radio frequency (RF) transceivers.

9. The system of claim 8, wherein the at least two different types of RF transceivers include a Bluetooth (BT) radio and a wireless (WiFi) radio.

10. The system of claim 8, wherein the at least two different types of RF transceivers in the media device further includes an Ad Hoc (AH) radio specifically configured for wireless communication with AH radios in other media devices, a cellular radio specifically configured for wireless communication with a cellular network or both.

11. (canceled)

12. (canceled)

13. The system of claim 1, wherein the power up comprises powering up the media device for a first time after an un-boxing of the media device.

14. The system of claim 1, wherein the P-Data includes a selected one or more of device type, device operating system (OS), device wireless communications protocols, names of wireless networks that are accessed by the user device, passwords for the wireless networks, device UI, and device data storage.

15. (canceled)

16. The system of claim 1, wherein the backend service is in communication with a storage system that includes the C-Data.

17. A method for auto-detection and auto-configuration, comprising:
powering up a media device that includes a plurality of radio transceivers;
detecting, using at least one of the plurality of radio transceivers, a radio frequency (RF) signature from another device;
analyzing the RF signature to determine protocol compatibility of the RF signature with one or more of the plurality of radio transceivers;
establishing a wireless communications link between the media device and the another device using the radio transceiver from the plurality of radio transceivers that is protocol compatible with the RF signature of the another device;
querying the another device to gather prerequisite configuration data from the another device;
analyzing on a backend service, the prerequisite configuration data (P-Data);
generating configuration data (C-Data) based on the analyzing;
downloading the C-Data to the media device, the another device, or both; and
configuring the media device, the another device, or both using the C-Data.

18. The method of claim 17, wherein the configuration data that is downloaded to the another device comprises an application (APP).

19. The method of claim 17, wherein the backend service does the generating of the C-Data.

20. A media device, comprising:
a controller in electrical communication with
a data storage system including non-volatile memory,
an input/output (I/O) system,
a radio frequency (RF) system including at least one RF antenna electrically coupled with a plurality of radio transceivers, each radio transceiver configured to wirelessly communicate with a different wireless protocol,
an audio/video (NV) system including a loudspeaker electrically coupled with a power amplifier and a microphone electrically coupled with a preamplifier, and
a power system configured to supply electrical power to the controller, the data storage system, the I/O system, the RF system, and the NV system,
wherein at power up, the media device is configured to activate the RF system to detect an RF signature of another device, to analyze the RF signature for protocol compatibility with the different wireless protocols of the plurality of radio transceivers, to establish a wireless connection with the another device and a backend service using at least one of the plurality of radio transceivers, and
wherein the backend service is operative to query the another device over the wireless connection, to gather and analyze prerequisite configuration data (P-Data) from the query, to generate configuration data (C-Data) from the P-Data, and to download the C-Data to the media device, the another device, or both.

21. The media device of claim 20, wherein the C-Data downloaded to the media device is operative to configure the media device.

22. The media device of claim 20, wherein one of the plurality of radio transceivers comprises an ad hoc (AH) radio transceiver configured to wirelessly communicate only with other media devices having the AH radio transceiver.

23. The media device of claim 20, wherein the power up comprises powering up the media device for a first time after an un-boxing of the media device.
